(19) United States
(12) Patent Application Publication
(10) Pub. No.: US 2004/0027222 A1
(43) Pub. Date: Feb. 12, 2004

(54) Ignition apparatus having high density cylindrical laminated core

(76) Inventors: John E. Hazelwood, Anderson, IN (US); Viorel N. Moga, Anderson, IN (US); Thomas B. Bennett, Anderson, IN (US); Albert Anthony Skinner, Anderson, IN (US)

Correspondence Address: MARGARET A. DOBROWITSKY, DELPHI TECHNOLOGIES, INC., Legal Staff, Mail Code: 480-410-202, P.O. Box 5052, Troy, MI, 48007-5052, US

(21) Appl. No.: 10/214,038

(22) Filed: Aug. 6, 2002

(51) Int. Cl. C04B 35/00

(52) U.S. Cl. 336/174; 336/231

(57) ABSTRACT

An ignition coil for a spark ignition internal combustion engine has a central core. The central core is cylindrical in shape, and includes a plurality of laminations composed of magnetically-permeable plates that are sector-shaped. The sector-shaped laminations improve the fill percentage allotted for core material. The central core has a central bore extending therethrough that allows a return of a primary winding lead, allowing an odd number of primary winding layers.

### TECHNICAL FIELD

The present invention relates to a ignition apparatus having a high density cylindrical laminated core.

### BACKGROUND OF THE INVENTION

An ignition coil for an internal combustion engine that is of a slender configuration, installed directly on an engine, and that is configured to be directly coupled to a spark plug is known, as seen by reference to U.S. Pat. No. 5,870,012 to Sakamaki et al. Sakamaki et al. disclose an ignition coil device that has core composed of laminations of iron plates having different widths with a stepped, nearly circular cross section, which is typical of conventional designs, as shown in FIG. 1.

One problem, however, with a stepped, lamination core design relates to a reduced fill percentage. The core is conventionally inserted in the hollow interior of a cylindrical coil bobbin or the like. The non-circular outside contour of a stepped core leaves significant volumes of space unfilled, thereby reducing performance.

Another limitation with using a conventional lamination core of the type disclosed in Sakamaki et al. relates to an encapsulant thickness consistency. When such an ignition coil is assembled, a primary winding may be wound on the central core, which then follows the contour of the outer surface of the central core. A secondary winding spool or the like is then disposed outwardly of the primary winding and core assembly. When the ignition coil is completed, the interior is filled with an encapsulant, as known, which flows into the space between the outside of the primary winding and the inside of the secondary winding spool (i.e., which is circular). However, since the outside of the primary winding exhibits some radial variation relative to the inside diameter of the secondary spool (see FIG. 1 where, with respect to a reference circle 20, area 22 is radially thinner than area 24), the encapsulant thickness thus also varies. In addition, each individual lamination may have a variation of between about ±1.5 thousandths of an inch, which upon stack-up results in a possible large overall variation in size and shape. The foregoing encapsulant variation may result in curing nonuniformities and/or different expansion characteristics during operation. Either of the foregoing may result in separation of the encapsulant, which may impair the operation of the ignition coil. Moreover, two or more of the different widths may be made from the same width stock, thereby requiring a trimming operation, which increases waste and complexity.

It is also known to use bundles of magnetic wire to form a central core. However, it is believed that the manufacturing of such a core is rather complicated.

There is therefore a need for an improved ignition apparatus for an internal combustion engine that minimizes or eliminates one or more problems as set forth above.

### SUMMARY OF THE INVENTION

An object of the present invention is to solve one or more of the problems as set forth in the Background. The invention involves the use of sector-shaped, radially oriented laminations for forming a circular central core of an ignition coil. One advantage is that it provides a higher density core to increase performance in a given diameter and length package (i.e., increasing the fill percentage by reducing and/or eliminating unused space). Another advantage is that by providing an outer cylindrical surface, the consistency or uniformity of the radial thickness of the encapsulant between the primary winding and the inside diameter of the secondary spool is greatly improved. Still another advantage is that the cost of tooling needed to produce such a core is reduced. Yet another advantage is that manufacture of the inventive core results in reduced scrap material. Still yet another advantage of the invention, for an embodiment having a central through-bore, is that it provides the capability of having an odd number of primary winding layers, since the central bore allows for the return of the lead to the low-voltage (top) end of the ignition coil.

An ignition apparatus for an internal combustion engine comprises a magnetically-permeable central core, a primary winding and a secondary winding. The primary and secondary windings are disposed outwardly of the central core. The central core includes a plurality of sectors formed of magnetically-permeable material extending along an axis to form a cylindrical configuration. Each sector is insulated from one another. In one embodiment, the central core may optionally be configured with a central bore extending through the core.

A method of making a cylindrical core for an ignition apparatus according to the invention is also presented.

### BRIEF DESCRIPTION OF THE DRAWINGS

Additional objects and advantages of the present invention will be more readily apparent from the following detailed description of preferred embodiments thereof when taken together with the accompanying drawings in which:

FIG. 1 is a radial cross-section view of a conventional central core composed of laminations of iron plates.

FIG. 2 is a radial cross-section view of a central core according to the invention composed of a plurality of sector-shaped laminations.

FIG. 3 is a cross-section view of an alternate embodiment of the laminations shown in FIG. 2.

FIG. 4 shows an apparatus for performing a method of making the inventive central core according to a progressive rolling process.

FIG. 5 shows a further apparatus for arranging and retaining the individual laminations produced by the apparatus of FIG. 4.

FIG. 6 is a end view of the core taken substantially in the direction of the lines designated 6-6 in FIG. 5.

FIG. 7 shows yet a further apparatus for performing a method of making the inventive central core according to a coining process.

FIG. 8 is an end view of the core taken substantially in the direction of the lines designated 8-8 in FIG. 7.

FIG. 9 shows a still further apparatus configured to implement a coining and cutting function illustrated in FIG. 7.

FIG. 10 is a sectional view of an exemplary ignition coil suitable for use with the inventive central core.

FIG. 11 is a section view of an application of one embodiment of the invention that allows the use of an odd number of layers for the primary winding.

FIG. 12 is an exploded view of an ignition coil having the inventive central core as suitable for installation to a spark plug in an engine, and as may be controlled by a control unit.

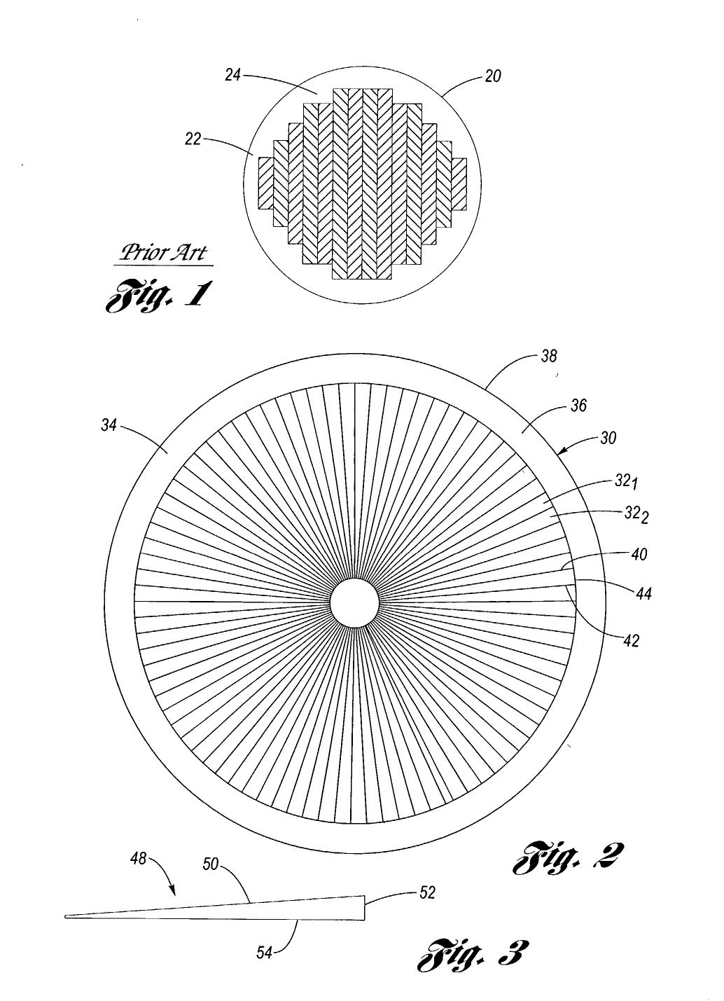

### DETAILED DESCRIPTION OF THE PREFERRED EMBODIMENTS

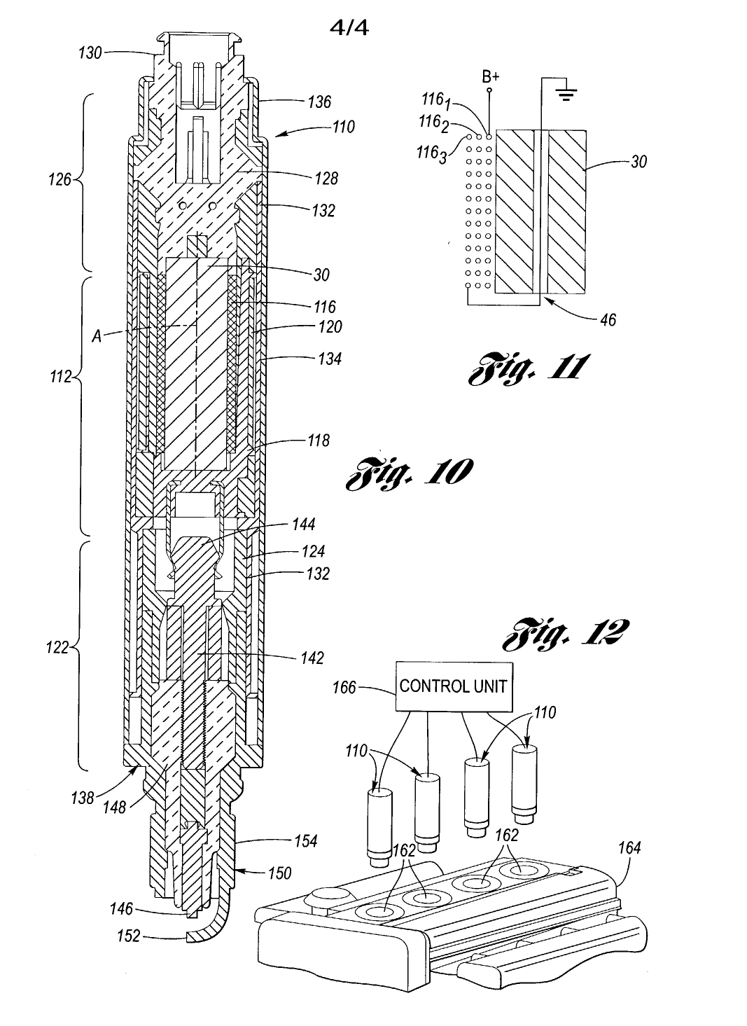

Referring now to the drawings wherein like reference numerals are used to identify identical components in the various views, FIG. 2 shows a central core 30 in accordance with the present invention. Core 30 is composed of a plurality of sector-shaped laminations 32₁, 32₂, . . . , 32ₙ formed of magnetically-permeable material, such as plates of silicon steel or the like. Sector-shaped laminations 32₁, 32₂, . . . , 32ₙ extend along a main axis designated “A,” which axis is best shown in FIG. 10. Collectively, the plurality of laminations 32₁, 32₂, . . . , 32ₙ form a cylindrical configuration. As known in the art, each lamination 32₁, 32₂, . . . , 32ₙ is coated with an electrical insulating material configured to reduce losses due to eddy currents, when all the lamination are arranged together in contact and a magnetic field is passed therethrough.

Core 30 is characterized by a substantially uniform, circular outside diameter. In one embodiment, diametrical variation ±0.001″ is achieved in cross-sectional terms. As shown in FIG. 2, for example, areas 34 and 36 are substantially, radially uniform with respect to a circle 38 (e.g., an inside diameter surface of a secondary winding spool). The foregoing provides an increased density core (i.e., increased space utilization by reducing and/or eliminating void space characteristic of conventional parallel, stepped iron plate arrangements). The increased uniformity also reduces and/or eliminates areas of increased encapsulant thickness, as described above. In addition, arranging the laminations 32₁, 32₂, . . . , 32ₙ in a radial fashion also reduces eddy current losses.

With continued reference to FIG. 2, each sector-shaped lamination 32₁, 32₂, . . . , 32ₙ includes a first radii 40, a second radii 42, and an included arc 44 of a circle that is substantially congruent with an outer circumference of core 30. FIG. 2 further shows core 30 having a central bore 46 extending longitudinally the length of core 30. As used herein, “sector” is not limited strictly to the geometrical definition of “sector”, but also encompasses other arrangements, such as where the pair of radii of each lamination 32₁, 32₂, . . . , 32ₙ do not meet in the strict center point of the circle defining the outer edge of the core, but rather meet on an outer diameter of central bore 46, as shown. Other variations are also possible.

FIG. 3 shows a second embodiment of sector-shaped laminations 32₁, 32₂, . . . , 32ₙ, namely lamination 48. Lamination 48 is the same as lamination 32₁, 322, . . . , 32ₙ in all salient respects, except that lamination 48 is a right-triangle in section, having a hypotenuse 50 and first and second legs 52 and 54. Right triangle lamination 48 closely approximates a “sector” for purposes of constructing core 30.

In both embodiments, scrap is greatly reduced relative to conventional approaches. In a conventional laminated core, different widths are used, which may begin from a common size (width) stock. Thus, trimming these sheets to the different, desired widths results in waste. The present invention overcomes this problem, because the laminations are all based on the same width.

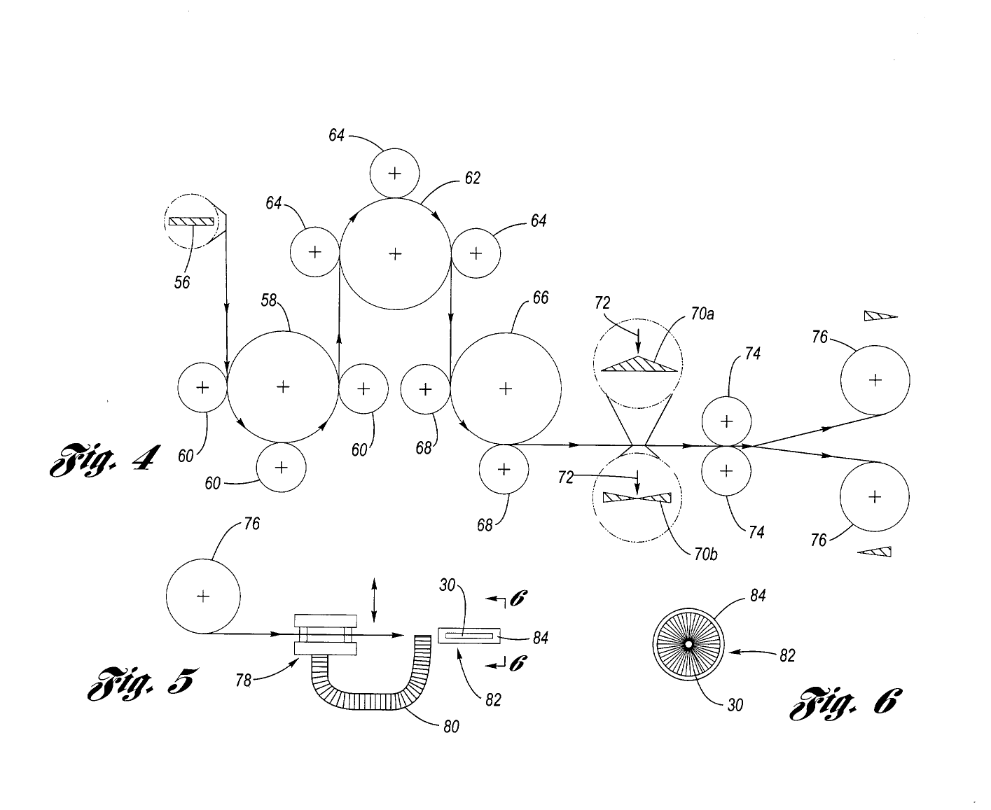

FIG. 4 shows an apparatus for performing a method of making a cylindrical central core for an ignition coil for an internal combustion engine. The process involves producing variable cross-section thickness laminations and assembling them into a cylindrical core.

The first step involves providing stock material, shown as a rectangular shaped sheet 56 in cross section. This may come in the form of a continuous sheet that is carried in a coil. The stock material sheet 56 may comprise magnetically-permeable material such as laminated electrical steel, silicon steel, cold rolled steel, or the like. The stock sheet 56 may be coated with an electrical insulating material, or such coating may be applied during or after the rolling process to be described in connection with FIG. 4. When the stock sheet 56 is uncoated, one of the process steps (other than forming the sector-shaped laminations 32₁, 32₂, . . . , 32ₙ) involves coating the processed material to insulate the laminations, to electrically isolate one from another in order to reduce losses due to eddy currents.

The next step involves rolling the stock material 56 so as to deform the stock material into a suitable shape. In the illustrated embodiment, the rolling is done in a progressive fashion, although such an approach need not be the case. FIG. 4 shows a first main roller device 58 in cooperative relation with counter rollers 60. Roller 58 and rollers 60 may each have a profile that is complementary in nature, so that through the deformation that occurs through rolling, the desired shape can be achieved. FIG. 4 also shows second main roller device 62 and its counter, complementary rollers 64, as well as a third main roller device 66 and its counter, complementary rollers 68. Each of the first, second and third main roller devices, in order, are shaped progressively closer to the final, desired shape. There may be a fewer or a greater number of roller stages than the exemplary first, second and third stages shown in FIG. 4.

At the output of the rolling stages, an intermediate lamination is produced, shown in two embodiments, designated a first rolled workpiece 70a and a second rolled workpiece 70b, respectively. Workpiece 70a is configured to yield two laminations 32₁, 32₂, . . . , 32ₙ per width of stock material sheet 56, after it has been separated with respect to a midline 72. Likewise, workpiece 70b is configured to yield two laminations 32₁, 32₂, . . . , 32ₙ per width of stock material sheet 56, after it has been separated with respect to midline 72. It should be understood, however, that the rolling process may be configured to yield just one lamination per width of stock material 56.

The next step in the illustrated embodiment is to separate, for example by way of cutting, the first rolled workpiece 70a (or 70b as the case may be) into two separate coils each having the shape of laminations 32₁, 32₂, . . . , 32ₙ. This step may be performed using slitters 74 or a zero clearance shear, or in other ways known to those of ordinary skill in the art. The resulting items may be collected for further processing. In the illustrated embodiment, the resulting items that have the profile of laminations 32₁, 32₂, . . . , 32ₙ are re-coiled on spools 76 (i.e., the process leaves a continuous strip).

FIG. 5 shows another apparatus for the further performance of the method of making the inventive core 30. FIG. 5 shows the coiled, formed profiles, in continuous form, on spool 76 that were made using the apparatus of FIG. 4. The next step in the processing involves cutting the lamination profile into the proper lengths and widths according to the overall design of the core 30. In this regard, a cutoff device 80 is provided for cutting the material from spool 76 to the proper length for making a core. The resulting laminations 32₁, 32₂, . . . , 32ₙ are then loaded into a lamination magazine 80 so as to facilitate creating a cylindrical core 30. The magazine 80 is exaggerated in size to enhance clarity.

The next step is to fix the plurality of sector-shaped laminations 32₁, 32₂, . . . , 32ₙ one to another. While it is possible to attach the individual laminations 32₁, 32₂, . . . , 32ₙ together via a conventional process such as welding or fusion or the like, in a preferred embodiment, a core assembly 82 is formed using a core retainer 84 into which the laminations 32₁, 32₂, . . . , 32ₙ of core 30 are transferred. The core retainer 84 is preferably formed of electrical insulating material, and may be selected from the group comprising a plastic tube, a shrink plastic tube, tape, a plastic overmold, or similar technologies or approaches known to those of ordinary skill in the art. The foregoing step will ensure that the resulting core is a self-supporting core. Another benefit of the core retainer 84 is that it provides protection for the wire insulation found on the primary winding conductors from any edges of the laminations 32₁, 32₂, . . ., 32ₙ.

FIG. 6 is an end view of the final core assembly 82 taken substantially in the direction of line 6-6 in FIG. 5.

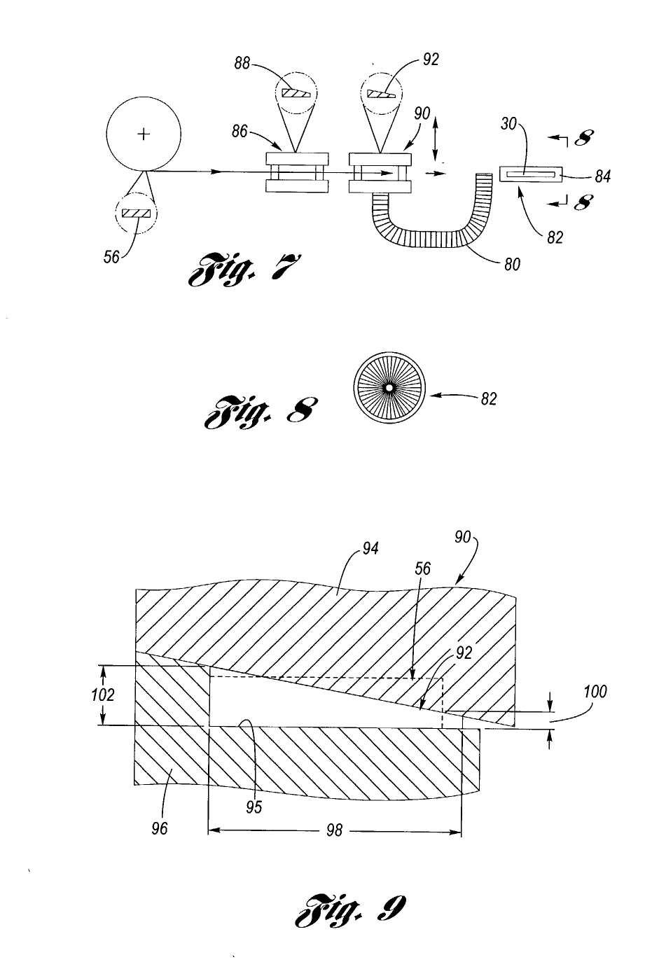

FIG. 7 illustrates an alternate, coining process for making a core according to the present invention. The process begins with stock material sheet 56, just as in the process depicted in FIG. 4. The stock material sheet 56 is preferably a continuous sheet of material, so as to facilitate continuous manufacture, as in the rolling formation embodiment of FIGS. 4-6. As shown in FIG. 7, a first coining device 86 is controlled to deform the original stock material sheet 56 by a predetermined amount to produce a first coined workpiece 88. Coining is a process (as its name suggests) similar to a punch and die operation. FIG. 7 further shows a second coining device 90 that is controlled to further deform first coined workpiece 88 to produce a second coined workpiece 92. Workpiece 92 is characterized by the desired, final shape. Device 90 is configured, in the illustrated embodiment, to also cut the continuous sheet workpiece 92 to the desired length for core 20, and load the finished laminations 32₁, 32₂, . . . , 32ₙ into magazine 80. Further processing occurs in a manner identical to that described above in connection with FIGS. 4-6. It should be understood that the final lamination shape may be obtained through a greater or lesser number of coining stages.

FIG. 8 is an end view of the final core assembly 82 taken substantially in the direction of line 8-8 in FIG. 7.

FIG. 9 shows in greater detail the device 90 in FIG. 7. As described above, device 90 may be configured to perform both a cut operation and a coining operation at substantially the same time. In this regard, device 90 includes a punch 94 and a die 96. The outline of the original shape of the stock material 56 is shown in dashed-line format. The final lamination 32₁, 32₂, . . . , 32ₙ is shown in solid line format. The heights designated by reference numerals 100 and 102 can be controlled in a manner known in the art via suitable selection of the particulars of the punch and die design. Variation of a length 98 can be accomodated through the use of central bore 46 (best shown in FIG. 2). Variation in the height of a core 30 made using the laminations 32₁, 32₂, . . . , 32ₙ can be handled by placing the inconsistent heights at one end of the core and putting this end inside a core cap or the like. It should be noted that surface 95 in FIG. 9 is not significantly damaged during the coin and cut operation. Accordingly, any coating, such as an electrical insulating coating, would not be significantly damaged, and may be relied upon in the final core design.

FIG. 10 show an embodiment of an ignition coil 110 using a core 30 in accordance with the present invention. This coil 110 is being shown and described only as an example of how one of ordinary skill may use the present invention. Other variations are clearly possible, as known in the art. The coil 110 is adapted for installation to a conventional internal combustion engine 164 through a spark plug shell and in threaded engagement with a spark plug opening 162 into a combustion cylinder (best shown in FIG. 12).

FIG. 10 illustrates coil 110 having a transformer portion 112 comprising the inventive core 30, a primary coil 116, a secondary spool 118 and a secondary coil 120, a connection portion 122 comprising a high-voltage boot 124, a control circuit portion 126 comprising an assembled connector portion 128 and a circuit interface portion 130, a coil case 132, an outer housing or shield 134 comprising a fastening head 136, and a spark plug assembly 138. As further shown in FIG. 10, spark plug assembly 38 comprises a central electrode 42 having a first end 44 and a second end 46, an insulator portion 48, and a shell 50 comprising a second electrode portion 52, and a threaded portion 54.

With continued reference to FIG. 10, coil 110 has a substantially rigid outer housing 134 at one end of which is the spark plug assembly 138 and at the other end of which is the control circuit interface portion 130 for external electrical interface with a control unit 166, such as an engine control unit. The primary and secondary windings 116, 118 are arranged in a substantially coaxial fashion along with core 30. Generally, the structure is adapted for drop in assembly of components and subassemblies as later described.

Transformer portion 112 and control-circuit portion 126, for high-voltage generation, are inserted into outer housing 134. The control-circuit portion 126 responds to instruction signals from an external circuit (not shown) to cause a primary current to initially flow through primary coil 116 and then be interrupted when a spark is desired. The control circuit 126 may be external to coil 110. Connecting portion 122, which supplies a relatively high secondary voltage generated by the transformer portion 112 to the spark plug 138, is provided in a lower portion of the outer housing 134.

The outer housing 134 may be formed from round tube stock for example comprising nickel-plated 1008 steel or other adequate magnetic material. Where higher strength may be required, such as for example in unusually long cases, a higher carbon steel or a magnetic stainless steel may be substituted. A portion of the outer housing 134 at the end adjacent to the control circuit interface portion 130 may be formed by a conventional swage operation to provide a plurality of flat surfaces, thereby providing a fastening head 136, such as a hexagonal fastening head for engagement with standard sized drive tools. Additionally, the extreme end is rolled inward to provide necessary strength for torque applied to the fastening head 136 and perhaps to provide a shelf for trapping a ring clip between the outer housing 134 and the connector body 130. The previously assembled primary and secondary subassemblies are loaded into the outer housing 134 from the spark plug end to a positive stop provided by the swaged end acting on a top end portion of the connector body.

Although FIG. 10 does not show core retainer 84, the core 30 can be substituted with core assembly 82, which contains core 30 and core retainer 84.

The primary coil 116 may be, as shown, wound directly on the surface of the core 30. Coil 116 may be formed from insulated wire, which may be wound directly upon the outer cylindrical surface of the core 30. The winding of the primary coil 116 directly upon the core 30 provides for efficient heat transfer of the primary resistive losses and improved magnetic coupling which is known to vary substantially inversely proportionally with the volume between the primary coil 116 and the core 30. The core 30 may be assembled to the interior end portion of the connector body to establish positive electrical contact between the core 30 and a core-grounding terminal. However, the specific grounding of the core 30 is not essential to the operation of the present invention. Terminal leads of primary coil 116 may be connected to insert molded primary terminals by conventional processes such as soldering. Alternative constructions are possible, for example, via use of steel laminations for the core 30 in combination with the primary coil wound on a primary coil spool (not shown). The foregoing is exemplary only and not limiting in nature.

The primary sub-assembly is inserted into the secondary coil spool 118. A secondary coil 120 may then be wound onto the outer periphery of the secondary spool 118. The secondary coil 120 may be either a segment wound coil or a layer (progressive) wound coil in a manner that is known to one of ordinary skill in the art.

The control-circuit portion 126 may contain a molded-resin switching element which controls a conduction current through the primary coil 116 to be intermittent, and a control circuit which is an igniter that generates the control signals of this switching element. Additionally, a heat sink, which may be a separate body, may be glued or otherwise adhered to the control-circuit portion 126 for heat radiation of circuit elements such as the switching element. However, as previously mentioned, the control-circuit portion 126 may be external to the spark plug assembly 138.

The interior of housing 134 retains the transformer portion 112, connector portion 128, and a high voltage boot 124. The coil case 132 is disposed within the outer housing 134 and is added for support and to support the coil. For the assembly process, the wound primary coil 116 with assembled connector 128 is assembled to the wound secondary spool 118 and then into the coil case 132.

The ignition coil 110 may be inserted in a plug hole of an internal combustion engine and is fixed to an engine. The spark plug assembly 138 that is mounted on a bottom portion of the plug hole is received within the connecting portion 122, and a high voltage terminal portion 144 of the spark plug 138 electrically contacts high voltage connector portion. The steel shield 134 may be welded to the spark plug to form a pre-assembled unit. The pre-assembled unit is then screwed into the spark plug hole in the engine head in the conventional manner. The unit may then be self-supporting with no attachment bolts required.

The ignition coil may have a cross-sectional configuration and dimensions that are housable within the plug hole 162. A tube-portion cross section of the outer housing 134 may be formed to be circular so that an inner-diameter dimension accommodates a plug hole 162, and an outer diameter thereof is established to be a suitable dimension as recognized by those skilled in the art.

FIG. 11 shows a particular application of a core 30 in accordance with the present invention. In particular, the core 30 as shown allows the use of an odd number of layers for the primary winding 116. The layers are shown as 116₁, 116₂ and 116₃ in FIG. 11. One end of the primary winding is connected to a relatively low voltage (such as a battery voltage in an automotive vehicle), and the other, selectively connected to ground, both as known. These connections are available at and are typically made at the low-voltage (LV) end or top end of the ignition coil. Generally, this has meant that only an even number of layers were possible (i.e., one layer “down” and one layer “back”). However, according to the invention, central bore 46 allows for the return of the lead, for example, that exists on the outermost layer to the top of the ignition coil for connection. This improves flexibility in ignition coil design.

FIG. 12 depicts several ignition coils 110 connected to a respective plug hole 162 of an engine 64. The coils are in turn connected to the engine control unit 166 that may include appropriate control logic to control the ignition coils, as known.

### EXAMPLE 1

A core 30 has a nominal core outside diameter of 9.50 mm, and a core inside diameter (i.e., that of central bore 46) of 1.00 mm. Each lamination 32 has a nominal radius of 0.167 inches, and an included arc having an arc length of approximately 0.008 inches wherein an angle subtended by the sector-shaped lamination is approximately 2.448°. Such core 30 requires approximately 147 sector-shaped laminations. A workpiece 70a for this example core 30 has an overall width of approximately 0.335 inches, and has a midpoint 72 depth of approximately 0.008 inches. A workpiece 70b for this example core 30 has an overall width of approximately 0.335 inches, and has a midpoint 72 depth or thickness of about 0.001 inches, and an end thickness of about 0.008 inches. Each of workpieces 70a and 70b is suitable for making two laminations per width.

### EXAMPLE 2

Core 30 in this example has a nominal diameter of 9.50 mm, with a core inside diameter of approximately 1.00 mm (i.e., that diameter of central bore 46). Approximately 84 sector-shaped laminations are required wherein a radial length of each lamination is approximately 0.167 inches, with an arc length of approximately 0.014 inches, and which subtends an angle of about 4.265°. A workpiece 70a for this example core has an overall width of approximately 0.335 inches, with a midline 72 thickness of approximately 0.014 inches, and an end thickness of about 0.0015 inches. A workpiece 70b for this example core is also approximately 0.335 inches in width, wherein a thickness at midpoint 72 is about 0.0015 inches, and wherein each end is approximately 0.014 inches in thickness. Each of workpieces 70a and 70b is suitable for making two laminations per width.

In both of the examples, the core 30 may be approximately 3 inches long (or high), as taken along main longitudinal axis A.

Although the present invention has been fully described in connection with the preferred embodiment thereof with reference to the accompanying drawings, it is to be noted that various changes and modifications will become apparent to those skilled in the art. Such changes and modifications are to be understood as being included within the scope of the present invention as defined by the appended claims.

1. An ignition apparatus for an internal combustion engine comprising:
a magnetically-permeable central core having a plurality of sectors each extending along an axis to form a cylindrical configuration;
a primary winding;
a secondary winding, wherein said primary and secondary winding are disposed outwardly of said core.

2. The ignition apparatus of claim 1 wherein said central core includes a central bore extending therethrough.

3. The ignition apparatus of claim 2 wherein said primary winding includes an odd number of layers, an end of a radially outermost layer of said primary winding being routed through said central bore.

4. The ignition apparatus of claim 1 wherein said sectors comprise silicon steel material.

5. The ignition apparatus of claim 1 further comprising a case of electrical insulating material radially outwardly of said core and primary and secondary windings.

6. The ignition apparatus of claim 1 further comprising an outer core radially outwardly of said case.

7. The ignition apparatus of claim 1 wherein at least one of said sectors has a shape, in radial cross-section, that is defined by a pair of radii and an included arc of a circle substantially congruent with an outer circumference of said central core.

8. The ignition apparatus of claim 1 wherein at least one of said sectors has a right-triangle shape in radial cross-section.

9. The ignition apparatus of claim 1 further comprising a core retainer configured to retain said plurality of sectors in said cylindrical configuration.

10. The ignition apparatus of claim 9 wherein said core retainer is selected from the group comprising a plastic tube, a shrink plastic tube, a length of insulating tape, and a plastic overmold.

11. The ignition apparatus of claim 10 wherein said primary winding is disposed directly over said core retainer.

12. The ignition apparatus of claim 1 further comprising a secondary winding spool having an inside diameter, and encapsulant disposed between the an outer layer of said primary winding and said inside diameter, said encapsulant being uniform in radial thickness.

13. The ignition apparatus of claim 1 wherein each sector is insulated.

14. An ignition apparatus for an internal combustion engine comprising:
a central core having a plurality of sectors each extending along an axis to form a cylindrical configuration, each sector being formed of magnetically-permeable material to thereby define a respective lamination;
a core retainer configured to retain said plurality of laminations;
a primary winding;
a second winding, wherein said primary and secondary winding are disposed outwardly of said central core;
a case of electrical insulating material disposed radially outwardly of said primary and secondary windings; and
an outer core of magnetically-permeable material radially outwardly of said case.

15. The ignition apparatus of claim 14 wherein said central core includes a central bore extending therethrough.

16. The ignition apparatus of claim 14 wherein at least one of said sectors has a shape, in radial cross-section, that is defined by a pair of radii and an included arc of a circle substantially congruent with an outer circumference of said central core.

17. The ignition apparatus of claim 14 wherein at least one of said sectors has a right-triangle shape in radial cross-section.

18. The ignition apparatus of claim 14 wherein each sector has an insulating coating.

19. A method of making a cylindrical core for an ignition apparatus comprising the steps of:
producing a plurality of sector shaped magnetically-permeable laminations;
loading a predetermined number of said laminations into a magazine to form a cylindrical configuration; and
retaining said laminations in said cylindrical configuration using a core retainer to produce a self-supporting cylindrical core.

20. The method of claim 19 wherein said producing step is performed by the substeps of:
passing stock material through a rolling device so as to produce opposing sectors having a midpoint; and
cutting said rolled stock material at said midpoint.

21. The method of claim 20 wherein said step of passing stock material is performed by a plurality of rollers each having a progressively increasing degree of deformation.

22. The method of claim 19 wherein said producing step is performed by the substeps of:
passing stock material through a coining device so as to produce a sector.

23. The method of claim 22 wherein said step of passing stock material is performed by using a plurality of coining devices each having a progressively increasing degree of deformation.

24. The method of claim 19 wherein said producing step is performed by the substep of:
extruding said plurality of laminations from stock material.
